(19) United States
(12) Patent Application Publication
(10) Pub. No.: US 2024/0100668 A1
(43) Pub. Date: Mar. 28, 2024

(54) PRESS TOOL ASSEMBLY

(71) Applicant: MILWAUKEE ELECTRIC TOOL CORPORATION, Brookfield, WI (US)

(72) Inventors: Alex H. Boll, Milwaukee, WI (US); Gabriel Sallum Dias Azevedo Alves, Milwaukee, WI (US)

(21) Appl. No.: 18/472,742

(22) Filed: Sep. 22, 2023

Related U.S. Application Data
(60) Provisional application No. 63/489,451, filed on Mar. 10, 2023.
(60) Provisional application No. 63/409,040, filed on Sep. 22, 2022.

(51) Int. Cl. B25B 27/14

(52) U.S. Cl. CPC B25B 27/14

(57) ABSTRACT

A press tool assembly includes a first jaw assembly and a second jaw assembly configured to be selectively coupled to a clevis, and a press ring having a plurality of links pivotably coupled to each other and configured to surround a fitting. The first jaw assembly includes a first jaw defining a first clamping portion and a second jaw defining a second clamping portion. The second jaw assembly includes a third jaw defining a third clamping portion and a fourth jaw defining a fourth clamping portion. The press ring includes first and second receiving portions configured to respectively receive the first and second clamping portions of the first jaw assembly. The third and fourth clamping portions are unable to engage the first and second receiving portions when the second jaw assembly is coupled to the clevis and in the closed configuration.

### CROSS REFERENCE TO RELATED APPLICATIONS

This application claims priority to co-pending U.S. Provisional Patent Application No. 63/489,451 filed Mar. 10, 2023 and co-pending U.S. Provisional Patent Application No. 63/409,040 filed Sep. 22, 2022, the entire contents of both of which are incorporated herein by reference.

### FIELD OF THE INVENTION

The present disclosure relates to a press tool assembly for crimping two pieces of tubing together.

### BACKGROUND OF THE INVENTION

A crimp or press-style fitting is typically a tubular sleeve containing seals. The fitting may be positioned on a pipe and a press tool assembly may be used to crimp the fitting to the pipe. The press tool assembly may include a press tool having jaws for directly crimping the fitting to the pipe. In some embodiments, the press tool assembly may include a press ring that is actuated by the jaws of the press tool to crimp the fitting.

### SUMMARY OF THE INVENTION

The invention provides, in one aspect, a press tool assembly configured to crimp a fitting to a pipe. The press tool assembly including a press tool having a housing, a drive unit supported within the housing, a clevis coupled to the housing and extending therefrom, a trigger configured to selectively activate the drive unit to initiate a crimping operation, and a first jaw assembly configured to be selectively coupled to the clevis and having a first jaw defining a first clamping portion and a second jaw defining a second clamping portion. The first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance. A second jaw assembly configured to be selectively coupled to the clevis and having a third jaw defining a third clamping portion and a fourth jaw defining a fourth clamping portion. The third jaw and the fourth jaw being pivotable between an open configuration, where the third clamping portion and the fourth clamping portion are separated from each other by a third distance that is greater than the first distance, and a closed configuration, where the third clamping portion and the fourth clamping portion are separated from each other by a fourth distance that is less than third distance. A press ring having a plurality of links pivotably coupled to each other and configured to surround the fitting. The press ring having a first receiving portion defined in a first link and a second receiving portion defined in a second link. The first and second receiving portions configured to respectively receive the first and second clamping portions of the first jaw assembly. The press ring movable between an open configuration, where the first and second receiving portions are separated by a first width, and a closed configuration, where the first and second receiving portions are separated by a second width less than the first width. The fourth distance is greater than first width so the third and fourth clamping portions are unable to engage the first and second receiving portions when the second jaw assembly is coupled to the clevis and in is the closed configuration.

The invention provides, in another aspect, a press tool assembly configured to crimp a fitting to a pipe. The press tool assembly including a press tool having a housing, a drive unit supported within the housing, a clevis coupled to the housing and extending therefrom, a trigger configured to selectively activate the drive unit to initiate a crimping operation, and a first jaw assembly configured to be selectively coupled to the clevis and having a first jaw defining a first clamping portion and a second jaw defining a second clamping portion. The first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance. A first press ring having a plurality of links pivotably coupled to each other and configured to surround the fitting, the first press ring having a first receiving portion defined in a first link and a second receiving portion defined in a second link. The first and second receiving portions configured to respectively receive the first and second clamping portions of the first jaw assembly. The first press ring movable between an open configuration where the first and second receiving portions are separated by a first width and a closed configuration where the first and second receiving portions are separated by a second width. A second press ring having a plurality of links pivotably coupled to each other and configured to surround the fitting, the second press ring having a third receiving portion defined in a first link and a fourth receiving portion defined in a second link. The second press ring movable between an open configuration where the third and fourth receiving portions are separated by a third width and a closed configuration where the third and fourth receiving portions are separated by a fourth width. The third width is greater than first distance such that the first and second clamping portions are unable to engage with the third and fourth receiving portions of the second press ring.

The invention provides, in yet another aspect, a press tool assembly configured to crimp a fitting to a pipe. The press tool assembly including a first jaw assembly configured to be coupled to the press tool and having a first jaw defining a first clamping portion and a second jaw defining a second clamping portion, the first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance, a second jaw assembly configured to be coupled to the press tool and having a third jaw defining a third clamping portion and a fourth jaw defining a fourth clamping portion, the third jaw and the fourth jaw being pivotable between an open configuration, where the third clamping portion and the fourth clamping portion are separated from each other by a third distance that is greater than the first distance, and a closed configuration, where the third clamping portion and the fourth clamping portion are separated from each other by a fourth distance that is less than the third distance, a first press ring having a plurality of links pivotably coupled to each other and configured to surround the fitting, the first press ring having a first receiving portion defined in a first link and a second receiving portion defined in a second link, the first and second receiving portions configured to respectively receive the first and second clamping portions of the first jaw assembly, the first press ring movable between an open configuration where the first and second receiving portions are separated by a first width and a closed configuration where the first and second receiving portions are separated by a second width, and a second press ring having a plurality of links pivotably coupled to each other and configured to surround the fitting, the second press ring having a third receiving portion defined in a first link and a fourth receiving portion defined in a second link, the second press ring movable between an open configuration where the third and fourth receiving portions are separated by a third width and a closed configuration where the third and fourth receiving portions are separated by a fourth width. The first distance is less than the third width so the first and second clamping portions are unable to engage the third and fourth receiving portions of the second press ring when the first jaw assembly is coupled to the press tool. The fourth distance is greater than the first width such that the third and fourth clamping portions are unable to engage with the first and second receiving portions of the first press ring when the second jaw assembly is coupled to the press tool.

Other features and aspects of the invention will become apparent by consideration of the following detailed description and accompanying drawings.

### BRIEF DESCRIPTION OF THE DRAWINGS

FIG. 1 is a perspective view of a press tool in accordance with an embodiment of the invention.

FIG. 2 is a perspective view of a jaw assembly for use with the press tool of FIG. 1.

FIG. 3 is a perspective view of a press ring for use with the press tool of FIG. 1 using the jaw assembly of FIG. 2.

FIG. 4 is a front view of the jaw assembly of FIG. 2 in an open configuration and the press ring of FIG. 3 in an open configuration.

FIG. 5 is a front view of the jaw assembly of FIG. 2 in a closed configuration and the press ring of FIG. 3 in a closed configuration.

FIG. 6 is a perspective view of the jaw assembly in accordance with another embodiment of the invention.

FIG. 7 is a perspective view of a press ring in accordance with another embodiment of the invention.

FIG. 8 is a front view of the jaw assembly of FIG. 6 in an open configuration and the press ring of FIG. 7 in an open configuration.

FIG. 9 is a front view of the jaw assembly of FIG. 6 in a closed configuration and the press ring of FIG. 7 in a closed configuration.

FIG. 10 is a perspective view of the jaw assembly in accordance with another embodiment of the invention.

FIG. 11 is a perspective view of a press ring in accordance with another embodiment of the invention.

FIG. 12 is a front view of the jaw assembly of FIG. 10 in an open configuration and the press ring of FIG. 11 in an open configuration.

FIG. 13 is a front view of the jaw assembly of FIG. 10 in a closed configuration and the press ring of FIG. 11 in a closed configuration.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

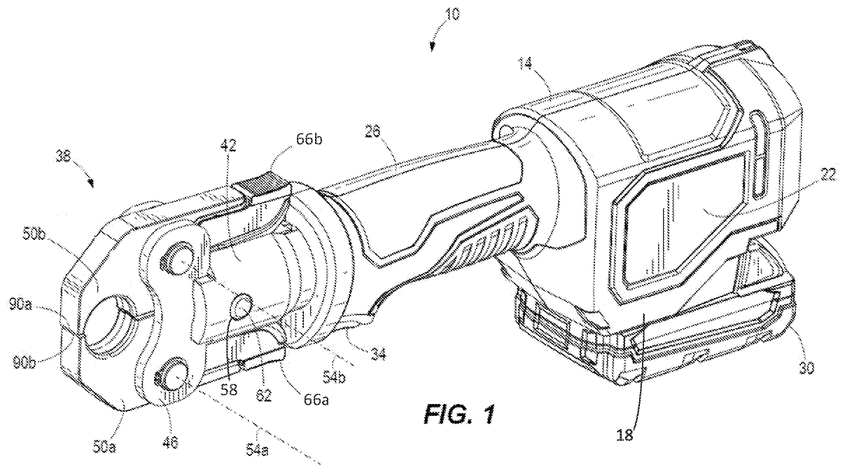

FIG. 1 illustrates a power tool, which in the illustrated embodiment is a press tool 10. The press tool 10 includes an outer housing 14 having a battery support portion 18, a drive unit support portion 22, and a handle portion 26 configured to be gripped by a user during operation of the press tool 10. A battery pack 30 is attachable to the battery support portion 18, while a drive unit (e.g., an electric motor and a transmission, not shown) is supported within the drive unit support portion 22. A trigger 34 for initiating a pressing operation is provided on the handle portion 26.

The press tool 10 also includes a jaw assembly 38 coupled to a clevis 42 which, in turn, is affixed to the handle portion 26. The jaw assembly 38 includes a bracket 46, a first jaw 50a pivotably coupled to the bracket 46 about a first pivot axis 54a, and a second jaw 50b pivotably coupled to the bracket 46 about a second pivot axis 54b parallel with the first pivot axis 54a. As such, the jaws 50a, 50b are pivotable about separate pivot axes 54a, 54b. In an alternative embodiment of the jaw assembly 38, the jaws 50a, 50b may be pivotable about a common pivot axis. The bracket 46 also includes an aperture 58 through which a pin 62 is insertable for affixing the bracket 46 (and thus the jaws 50a, 50b) to the clevis 42. Although not shown, the jaw assembly 38 includes a biasing member, such as a leaf spring, to bias the jaws 50a, 50b toward a closed configuration.

In operation of the press tool 10, the user may position a fitting (not shown) between the first and second jaws 50a, 50b by pressing an arm portion 66a, 66b of the respective jaws 50a, 50b, against the bias of the biasing member, thereby placing the jaws 50a, 50b in an open configuration in which respective clamping portions 90a, 90b are spaced from each other a sufficient distance to position the fitting between the clamping portions 90a, 90b of the jaws 50a, 50b. Once the fitting is positioned within the jaw assembly 38, the user may release the arm portions 66a, 66b. This will cause the biasing member to bias the clamping portions 90a, 90b towards each other and into contact the fitting. Once the clamping portions 90a, 90b are in contact with the fitting, the user may initiate a pressing operation by depressing the trigger 34, which activates the drive unit to apply a force to the arm portions 66a, 66b of the respective jaws 50a, 50b. The force applied to the arm portions 66a, 66b is in a direction substantially perpendicular to the axis of the drive unit, and causes the clamping portions 90a, 90b to move toward each other to press the fitting. In the illustrated embodiment, the jaw assembly 38 is configured to engage with a cylindrical fitting. In other embodiments, the fitting may have an alternate shape (e.g., hexagonal or the like).

It should be appreciated that the press tool 10 is an exemplary press tool and that other press tools may be used with the jaw assemblies described herein. In other words, the jaw assembly 38 of the illustrated embodiment is removably coupled to the press tool 10. In other embodiments, the jaw assembly 38 may be integrated with and non-removable from formed with the press tool 10. In yet other embodiments, the jaw assembly 38 may be coupled to a hydraulic pump through the clevis 42. In other words, the hydraulic pump forms the press tool.

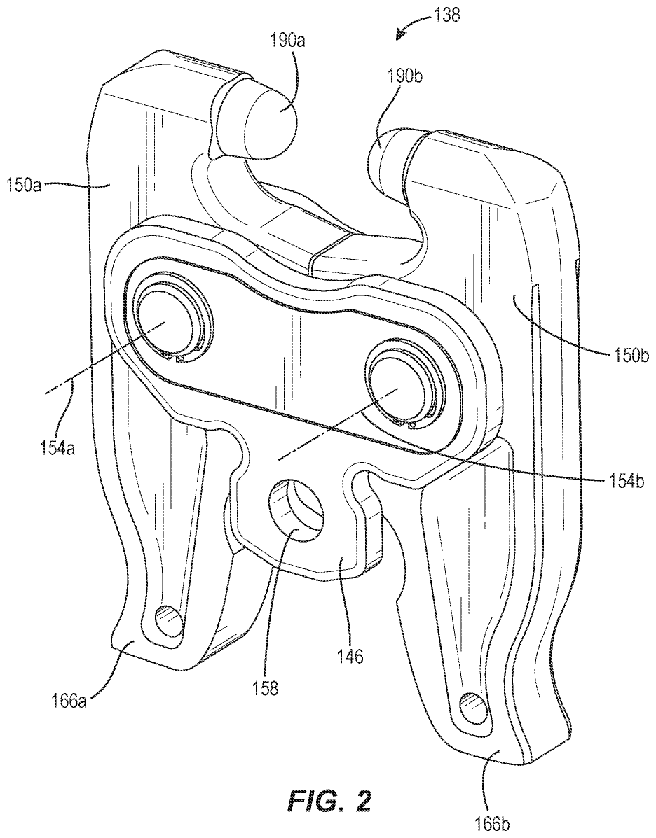

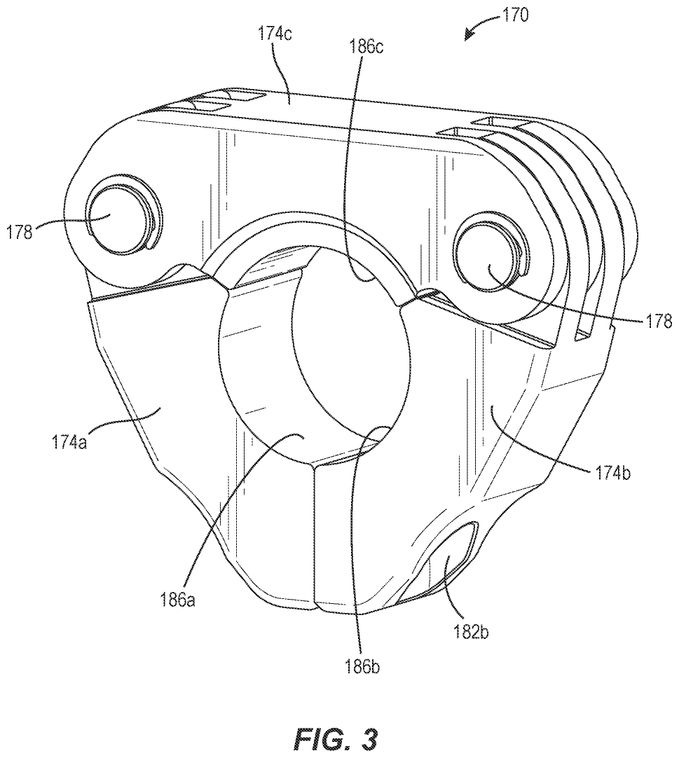

FIG. 2 illustrates an embodiment of a jaw assembly 138 for use with the press tool 10 of FIG. 1. The jaw assembly 138 is like the jaw assembly 38, with like features being identified with like reference numerals plus “100.” The jaw assembly 138 may replace the jaw assembly 38 so the press tool 10 can be used with a press ring 170 (FIG. 3), described in more detail below. The jaw assembly 138 includes a bracket 146, a first jaw 150a pivotably coupled to the bracket 146 about a first pivot axis 154a, and a second jaw 150b pivotably coupled to the bracket 146 about a second pivot axis 154b parallel with the first pivot axis 154a. As such, the jaws 150a, 150b are pivotable about separate pivot axes 154a, 154b. The jaws 150a, 150b define respective clamping portions 190a, 190b that are configured to engage the press ring 170. The jaw assembly 138 includes an aperture 158 sized the same as the aperture 58 through which the pin 62 (FIG. 1) is insertable for affixing the bracket 146 (and thus the jaws 150a, 150b) of the jaw assembly 138 to the clevis 42 of the press tool 10.

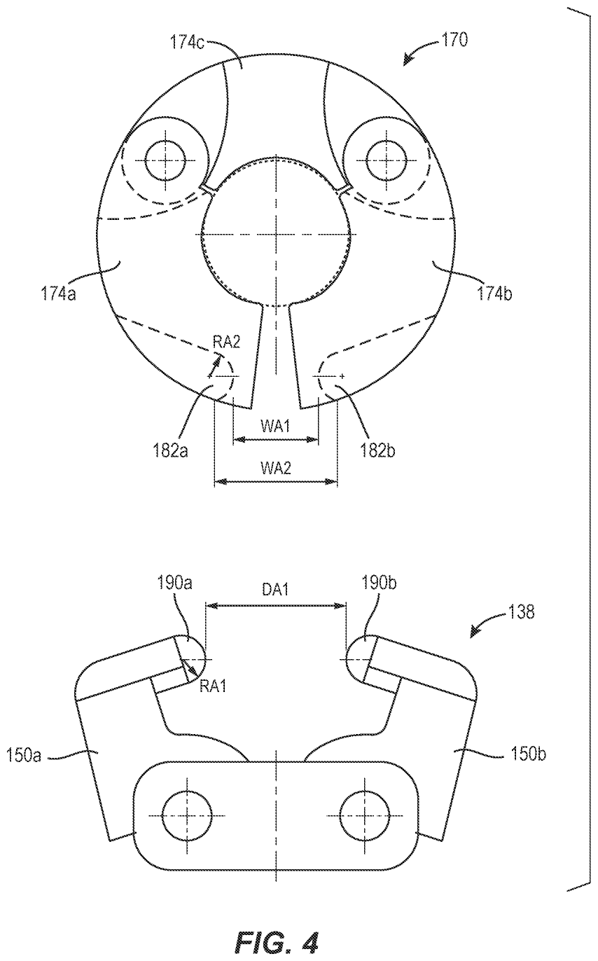

FIG. 3 illustrates an embodiment of a press ring 170 including a first link 174a, a second link 174b, and a third link 174c. The first link 174a and the second link 174b are rotatably coupled to the third link 174c with link pins 178. The first link 174a includes a first receiving portion 182a (FIG. 4) at the distal end of the first link 174a and the second link 174b includes a second receiving portion 182b at the distal end of the second link 174b. The links 174a, 174b, 174c include respective pressing portions 186a, 186b, and 186c that come together to form a first circular shape when the press ring 170 is in a closed configuration. The pressing portions 186a, 186b, 186c surround and contact a fitting to crimp the fitting onto a pipe.

FIG. 4 illustrates a schematic of the jaw assembly 138 in an open configuration and the press ring 170 in an open configuration. In the open configuration, the first and second clamping portions 190a, 190b of the jaw assembly 138 are separated from each other by a first distance DA1. In the open configuration, the first and second receiving portions 182a, 182b of the press ring 170 are separated from each other by an inner width WA1 and an outer width WA2 greater than the inner width WA1. The clamping portions 190a, 190b are configured to be pivotably received within the receiving portions 182a, 182b of the press ring 170. In the open configuration, the clamping portions 190a, 190b are separated from each other by the first distance DA1 that is greater than the inner width WA1 and the outer width WA2, which allows the clamping portions 190a, 190b to engage the receiving portions 182a, 182b.

The first and second clamping portions 190a, 190b are substantially spherical protrusions and have a radius RA1. The first and second receiving portions 182a, 182b are substantially spherical recesses that also have a radius of curvature RA2. The recesses define an innermost portion and an outermost edge. In the illustrated embodiment, the inner width WA1 is defined between the innermost portions of recesses and the outer width WA2 is defined between the outermost edges. The radii RA1 of the clamping portions 190a, 190b and the radius of curvatures RA2 of the receiving portions 182a, 182b are equal such that the clamping portions 190a, 190b can be received in the receiving portions 182a, 182b. In other embodiments, the radius RA1 of the clamping portions 190a, 190b may be smaller than the radius of curvature RA2 of the receiving portions 182a, 182b. The construction of the clamping portions 190a, 190b and the receiving portions 182a, 182b allows the press tool 10 to be pivoted relative to the press ring 170, which allows the operator to perform crimping operations in tight areas in which the press tool 10 may not otherwise fit.

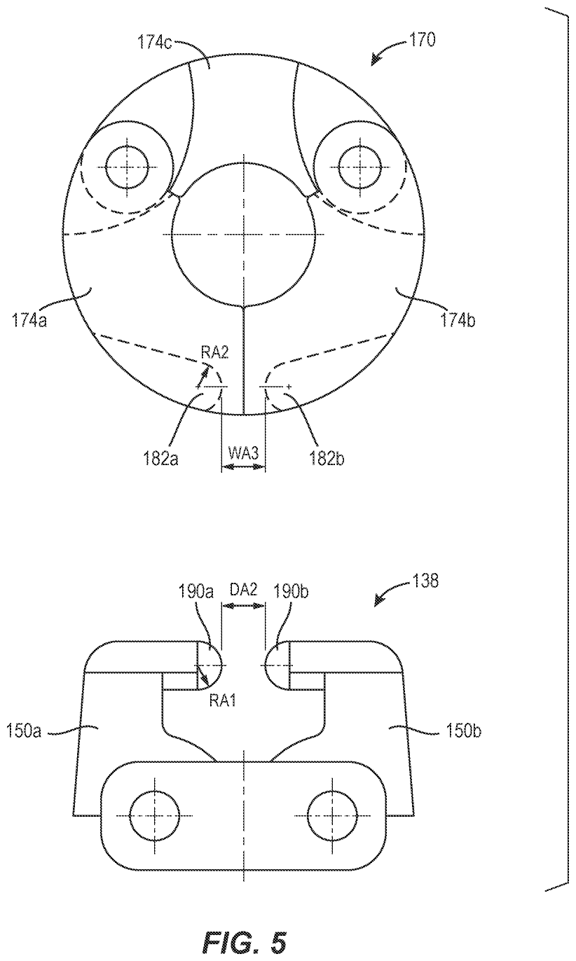

FIG. 5 illustrates a schematic of the jaw assembly 138 in a closed configuration and the press ring 170 in a closed configuration. In the closed configuration, the first and second clamping portions 190a, 190b of the first and second jaws 150a, 150b are separated from each other by a second distance DA2, which is smaller than the first distance DA1. In the closed configuration, the first and second receiving portions 182a, 182b of the press ring 170 are separated from each other by an inner width WA3, which is equal to the second distance DA2. In other words, the inner width WA3 and second distance DA2 are equal so that the jaw assembly 138 will completely close on the press ring 170, completing a crimping operation on a fitting as described above.

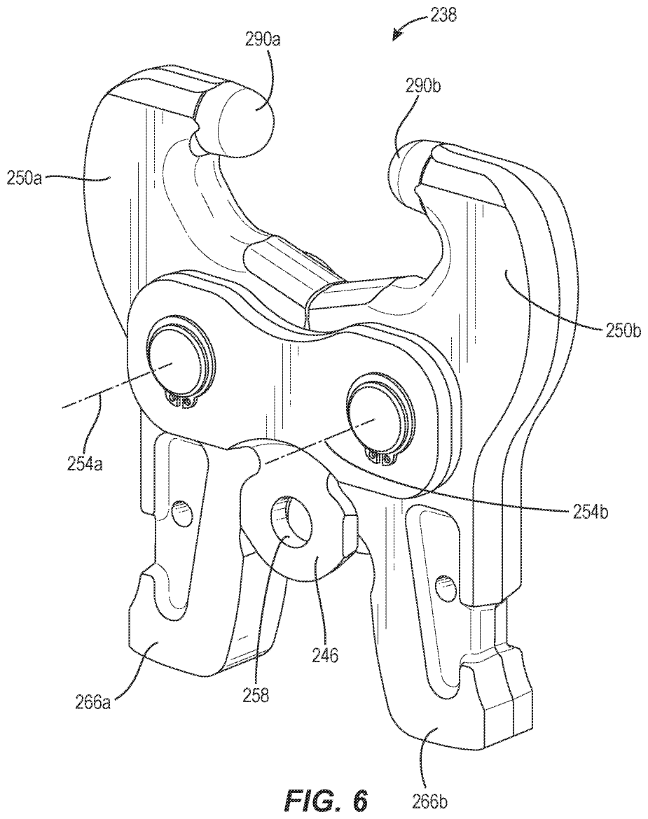

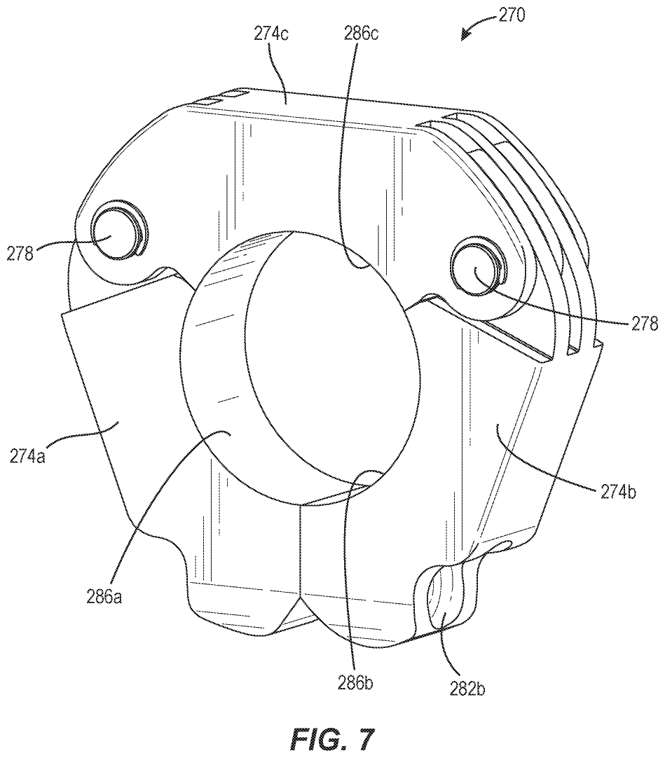

FIG. 6 illustrates another embodiment of a jaw assembly 238 for use with the press tool 10 of FIG. 1. The jaw assembly 238 is like the jaw assembly 38, with like features being identified with like reference numerals plus “200.” The jaw assembly 238 may replace the jaw assembly 38 so the press tool 10 can be used with a press ring 270 (FIG. 7), described in more detail below. The jaw assembly 238 includes a bracket 246, a first jaw 250a pivotably coupled to the bracket 246 about a first pivot axis 254a, and a second jaw 250b pivotably coupled to the bracket 246 about a second pivot axis 254b parallel with the first pivot axis 254a. As such, the jaws 250a, 250b are pivotable about separate pivot axes 254a, 254b. The jaws 250a, 250b define respective clamping portions 290a, 290b that are configured to engage the press ring 270. The jaw assembly 238 includes an aperture 258 sized the same as the aperture 58 through which the pin 62 (FIG. 1) is insertable for affixing the bracket 246 (and thus the jaws 250a, 250b) of the jaw assembly 238 to the clevis 42 of the press tool 10.

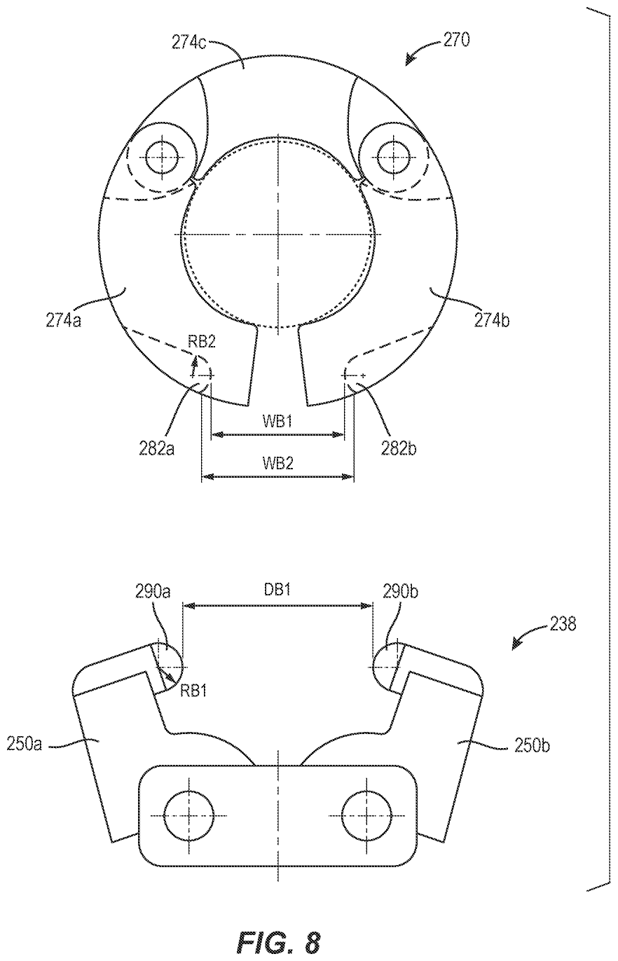

FIG. 7 illustrates an embodiment of a press ring 270 including a first link 274a, a second link 274b, and a third link 274c. The first link 274a and the second link 274b are rotatably coupled to the third link 274c with link pins 278. The first link 274a includes a first receiving portion 282a (FIG. 8) at the distal end of the first link 274a and the second link 274b includes a second receiving portion 282b at the distal end of the second link 274b. The links 274a, 274b, 274c include the respective pressing portions 286a, 286b, and 286c that come together to form a second circular shape when the press ring 270 is in a closed configuration. The pressing portions 286a, 286b, 286c surround and contact the fitting to crimp the fitting onto a pipe. The second circular shape is larger than the first circular shape formed by the pressing portions 186a, 186b, 186c of the press ring 170 (FIG. 3).

FIG. 8 illustrates a schematic of the jaw assembly 238 in an open configuration and the press ring 270 in an open configuration. In the open configuration, the first and second clamping portions 290a, 290b of the first and second jaws 250a, 250b are separated from each other by a first distance DB1. The first distance DB1 of the jaw assembly 238 is greater than the first distance DA1 of the jaw assembly 138 in the open configuration. In the open configuration, the first and second receiving portions 282a, 282b of the press ring 270 are separated from each other by an inner width WB1 and an outer width WB2 greater than the inner width WB1. The clamping portions 290a, 290b are configured to be pivotably received within the receiving portions 282a, 282b of the press ring 270. In the open configuration, the clamping portions 290a, 290b, are separated from each other by the first distance DB1 that is greater than the outer width WB2, which allows the clamping portions 290a, 290b to engage the receiving portions 282a, 282b. Further, the first distance DA1 (FIG. 4) that the clamping portions 190a, 190b of the jaw assembly 138 are separated by is less than the outer width WB2 of the press ring 270. As such, the clamping portions 190a, 190b of the jaw assembly 138 are unable to engage the receiving portions 282a, 282b of the press ring 270. In other words, the jaw assembly 138 is not compatible with the press ring 270.

The first and second clamping portions 290a, 290b are substantially spherical protrusions and have a radius RB1, which is greater than the radius RA1 of the clamping portions 190a, 190b of the jaw assembly 138. The first and second receiving portions 282a, 282b are substantially spherical recesses that also have a radius of curvature RB2. The recesses define an innermost portion and an outermost edge. In the illustrated embodiment, the inner width WB1 is defined between the innermost portions of recesses and the outer width WB2 is defined between the outermost edges. The radii RB1 of the clamping portions 290a, 290b and the radius of curvature RB2 of the receiving portions 282a, 282b are equal such that the clamping portions 290a, 290b can be received in the receiving portions 282a, 282b. In other embodiments, the radius RB1 of the clamping portions 290a, 290b may be smaller than the radius of curvature RB2 of the receiving portions 282a, 282b. Since the radius RB1 of the clamping portions 290a, 290b are greater than the radius of curvature RA2 of the press ring 170, the clamping portions 290a, 290b do not fit within the receiving portions 182a, 182b of the press ring 170. This alerts that user that jaw assembly 238 is not compatible with the press ring 170. The construction of the clamping portions 290a, 290b and the receiving portions 282a, 282b allows the press tool 10 to be pivoted relative to the press ring 270, which allows the operator to perform crimping operations fitting in tight areas that in which the press tool 10 does may not otherwise fit.

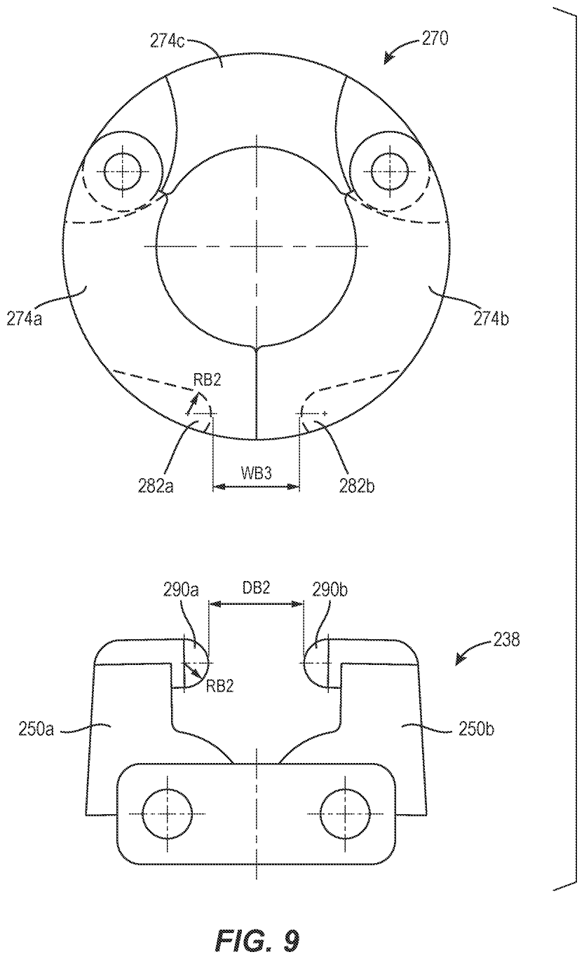

FIG. 9 illustrates a schematic of the jaw assembly 238 in a closed configuration and the press ring 270 in a closed configuration. In the closed configuration, the first and second clamping portions 290a, 290b of the jaw assembly 238 are separated from each other by a second distance DB2, which is smaller than the first distance DB1 of the jaw assembly 238 in the open configuration. The second distance DB2 is also greater than the second distance DA2 of the jaw assembly 138 in the closed configuration. In the closed configuration, the first and second receiving portions 282a, 282b of the press ring 270 are separated from each other by an inner width WB3, which is equal to the second distance DB2. In other words, the inner width WB3 and second distance DB2 are equal so that the jaw assembly 238 will completely close on the press ring 270, completing a crimping operation on a fitting as described above. Further, the second distance DB2 (FIG. 9) that the clamping portions 290a, 290b of the jaw assembly 238 are separated by is greater than the inner width WA1 and the outer width WA2 of the press ring 170 (FIG. 4). In particular, the second distance DB2 being greater than the inner width WA1 blocks the clamping portions 290a, 290b from being capable with the press ring 170 while the second distance DB2 being greater than the outer width WA2 visually alerts the operator that the jaw assembly 238 is not capable with the press ring 170. As such, the clamping portions 290a, 290b of the jaw assembly 238 are unable to engage the receiving portions 182a, 182b of the press ring 170. In other words, the jaw assembly 238 is not compatible with the press ring 170.

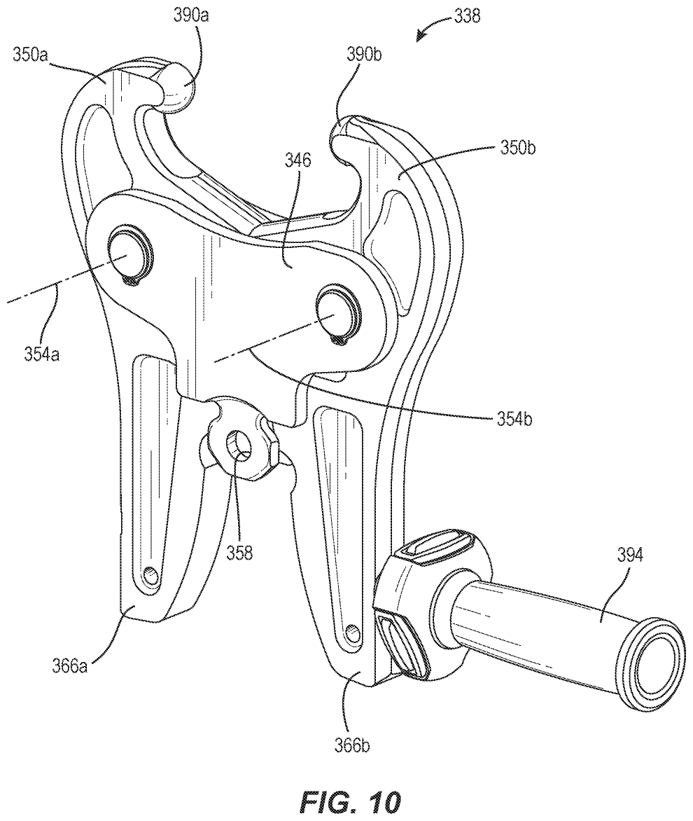

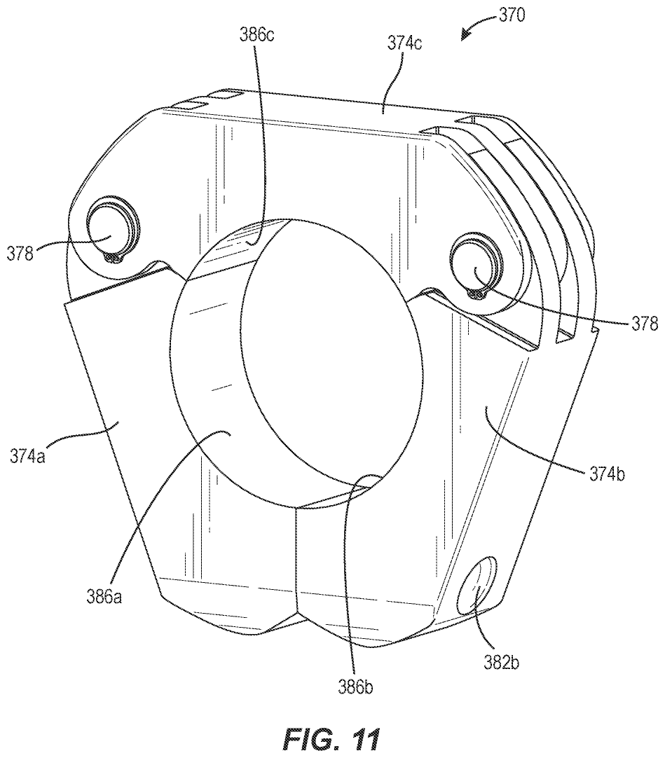

FIG. 10 illustrates another embodiment of a jaw assembly 338 for use with the press tool 10 of FIG. 1. The jaw assembly 338 is like the jaw assembly 38, with like features being identified with like reference numerals plus “300.” The jaw assembly 338 may replace the jaw assembly 38 so the press tool 10 can be used with a press ring 370 (FIG. 11), described in more detail below. The jaw assembly 338 includes a bracket 346, a first jaw 350a pivotably coupled to the bracket 346 about a first pivot axis 354a, and a second jaw 350b pivotably coupled to the bracket 346 about a second pivot axis 354b parallel with the first pivot axis 354a. As such, the jaws 350a, 350b are pivotable about separate pivot axes 354a, 354b. The jaws 350a, 350b define respective clamping portions 390a, 390b that are configured to engage the press ring 370. The jaw assembly 338 includes an aperture 358 sized the same as the aperture 58 through which the pin 62 (FIG. 1) is insertable for affixing the bracket 346 (and thus the jaws 350a, 350b) to the clevis 42 of the press tool 10. The jaw assembly 338 further includes a handle 394 that can be used by the user to provide extra support for the tool during the pressing operation. In some embodiments the handle 394 may be removably coupled to the jaw assembly 338. The handle 394 is not limited to the jaw assembly 338.

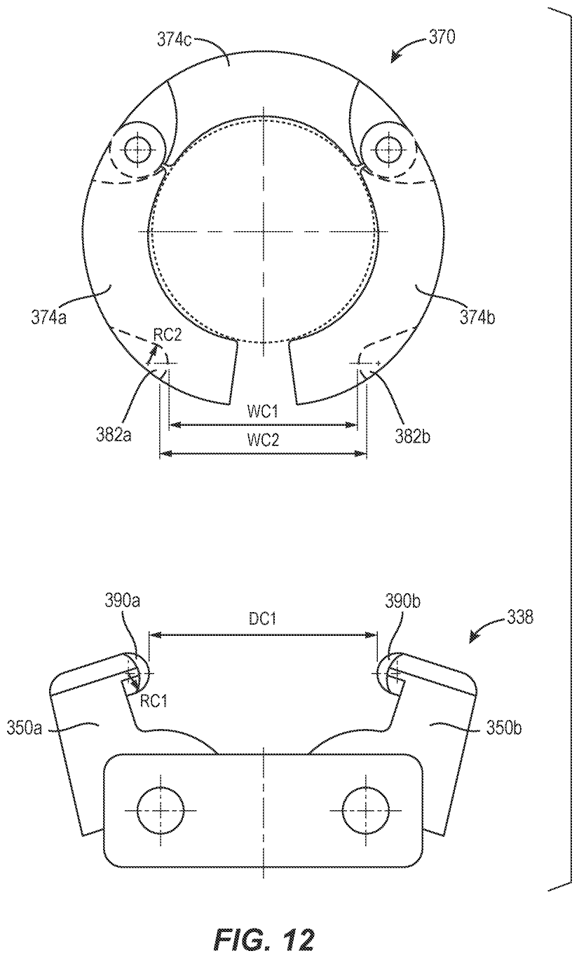

FIG. 11 illustrates an embodiment of a press ring 370 including a first link 374a, a second link 374b, and a third link 374c. The first link 374a and the second link 374b are rotatably coupled to the third link 374c with link pins 378. The first link 374a includes a first receiving portion 382a (FIG. 12) at the distal end of the first link 374a and the second link 374b includes a second receiving portion 382b at the distal end of the second link 374b. The links 374a, 374b, 374c include respective pressing portions 386a, 386b, and 386c that come together to form a third circular shape greater than the first and second circular shapes when the press ring 370 is in closed configuration. The pressing portions 386a, 386b, 386c surround and contact a fitting to crimp the fitting onto a pipe

FIG. 12 illustrates a schematic of the jaw assembly 338 in an open configuration and the press ring 370 in an open configuration. In the open configuration, the first and second end portions 390a, 390b of the first and second jaws 350a, 350b are separated from each other by a first distance DC1 greater than the first distance DA1 of the jaw assembly 138 in the open configuration and the first distance DB1 of the jaw assembly 238 in the open configuration. In the open configuration, the first and second receiving portions 382a, 382b of the press ring 370 are separated from each other by an inner width WC1 and an outer width WC2 greater than the inner width WC1. The clamping portions 390a, 390b are configured to be pivotably received within the receiving portions 382a, 382b of the press ring 370. In the open configuration, the clamping portions 390a, 390b, are separated from each other by the first distance DC1 that is greater than the outer WC2, which allow the clamping portions 390a, 390b to engage the receiving portions 382a, 382b.

The first and second clamping portions 390a, 390b are substantially spherical protrusions and have a radius RC1, which is greater than the radius RA1 of the clamping portions 190a, 190b of the jaw assembly 138 and the radius RB1 of the clamping portions 290a, 290b of the jaw assembly 138. The recesses define an innermost portion and an outermost edge. In the illustrated embodiment, the inner width WC1 is defined between the innermost portions of recesses and the outer width WC2 is defined between the outermost edges The first and second receiving portions 382a, 382b are substantially spherical recesses that also have a radius of curvature RC2. The radii RC1 of the clamping portions 390a, 390b and the receiving portions 382a, 382b are equal such that the clamping portions 390a, 390b can be received in the receiving portions 382a, 382b. In other embodiments, the radius of the clamping portions 390a, 390b may be smaller than the radius of the receiving portions 382a, 382b. Since the radius RC1 of the clamping portions 390a, 390b are greater than the radius of curvature RA2 of the press ring 170 and the radius of curvature RB2 of the press ring 270, the clamping portions 390a, 390b do not fit within the receiving portions 282a, 282b of the press ring 270 or the receiving portions 182a, 182b of the press ring 170. This alerts that user that second jaw assembly 338 is not compatible with either of the press ring 270 or the press ring 170.

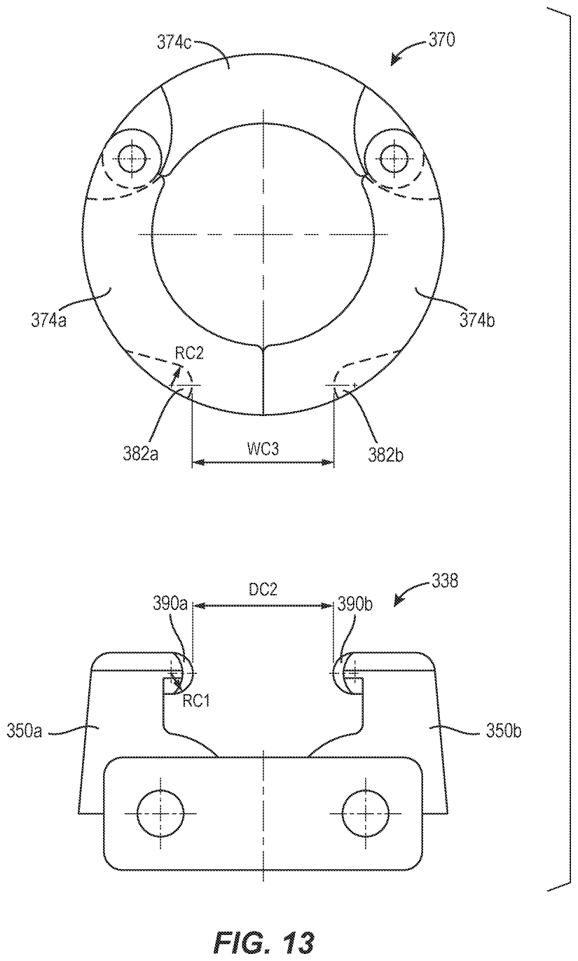

FIG. 13 illustrates a schematic of the jaw assembly 338 in a closed configuration and the press ring 370 in a closed configuration. In the closed configuration, the first and second clamping portions 390a, 390b of the jaw assembly 338 are separated from each other by a second distance DC2, which is smaller than the first distance DC1. The second distance DC2 is also greater than both the first distance DA2 of the jaw assembly 138 and the first distance DB2 of the jaw assembly 238. In the closed configuration, the first and second receiving portions 382a, 382b of the press ring 370 are separated from each other by an inner width WC3, which is equal to the second distance DC2. In other words, the inner width WC3 and second distance DC2 are equal so that the jaw assembly 338 will completely close on the press ring 370, and the press ring 370 will press the fitting in the desired manner. Further, the second distance DC2 (FIG. 13) that the clamping portions 390a, 390b of the jaw assembly 338 are separated by is greater than the inner width WB1 and the outer width WB2 of the press ring 270 (FIG. 9) and the inner width WA1 and the outer width WA2 of the press ring 170 (FIG. 4). In particular, the second distance DC2 being greater than the inner width WA1 blocks the clamping portions 390a, 390b from being capable with the press ring 170 and the second distance DC2 being greater than the inner width WB1 blocks the clamping portions 390a, 390b from being capable with the press ring 270. Additionally, the second distance DC2 being greater than the outer width WA1 of the press ring 170 and the outer width WA2 of the press ring 270 visually alerts the operator that the jaw assembly 338 is not capable with the press rings 170, 270. As such, the clamping portions 390a, 390b of the jaw assembly 338 are unable to engage the receiving portions 282a, 282b of the press ring 270 or the receiving portions 182a, 182b of the press ring 170. In other words, the jaw assembly 138 is not compatible with the press ring 270 or the press ring 170.

The jaw assemblies 138, 238, 338 are configured such that the respective first and second clamping portions 190a, 190b, 290a, 290b, 390a, 390b can only be received by the respective first and second receiving portions 182a, 182b, 282a, 282b, 382a, 382b of the respective press rings 170, 270, 370 to perform a pressing action.

The first and second clamping portions 190a, 190b of the jaw assembly 138 can only be received by the receiving portions 182a, 182b and cannot be received by the receiving portions 282a, 282b of the press ring 270 or the receiving portions 382a, 382b of the press ring 370. The distance DA1 between the clamping portions 190a, 190b in the open configuration is smaller than the width WB2 between the outermost edges of the receiving portions 282a, 282b in the open configuration and the width WC2 between the outermost edges of the receiving portions 382a, 382b in the open configuration.

The first and second clamping portions 290a, 290b of the jaw assembly 238 can only be received by the receiving portions 282a, 282b of the press ring 270 and cannot be received by the receiving portions 182a, 182b of the press ring 170 or the receiving portions 382a, 382b of the press ring 370. The radius RA1 of the clamping portions 190a, 190b is less than the radius RB1 of the clamping portions 290a, 290b. The radius of curvature RA2 of the receiving portions 182a, 182b is less than the radius of curvature RB2 of the receiving portions 282a, 282b. The radius RB1 of the clamping portions 290a, 290b is greater than the radius of curvature RA2 of the receiving portions 182a, 182b such that the clamping portions 290a, 290b of the jaw assembly 238 visually alert the operator that the clamping portions 290a, 290b are unable to engage with the receiving portions 182a, 182b when the jaw assembly 238 is coupled to the clevis 42 of the power tool 10. Further, the radius RA1 of the receiving portions 182a, 182b is less than the radius of curvature RB2 of the receiving portions 282a, 282b such that the clamping portions 190a, 190b visually alert the operator that the clamping portions 190a, 190b are unable to engage with the receiving portions 282a, 282b when the jaw assembly 138 is coupled to the clevis 42 of the power tool 10. In addition to the greater radius of RB1 compared to RA2, the first and second clamping portions 290a, 290b of the jaw assembly 238 can also not be received by the receiving portions 182a, 182b because the distance DB2 between the clamping portions 290a, 290b of the jaw assembly 238 in the closed configuration is greater than the width WA1 between the receiving portions 182a, 182b of the press ring 170 in the open configuration. In other embodiments, there may be only a difference in radius or only a difference in width which prevents the clamping portions 290a, 290b from being received by the receiving portions 182a, 182b. The distance DB1 between the clamping portions 290a, 290b in the open configuration is smaller than the width WC2 between the receiving portions 382a, 382b in the open configuration, such that the clamping portions 290a, 290b cannot be received by the receiving portions 382a, 382b.

The first and second clamping portions 390a, 390b of the jaw assembly 338 can only be receiving by the first and second receiving portions 382a, 382b of the press ring 370 and cannot be received by the receiving portions 182a, 182b of the press ring 170 or the receiving portions 282a, 282b of the press ring 270. The radius RC1 of the clamping portions 390a, 390b of the jaw assembly 338 is greater than the radius of curvature RA2 of the receiving portions 182a, 182b of the press ring 170 such that the clamping portions 390a, 390b of the jaw assembly 338 visually alert the operator that the clamping portions 390a, 390b are unable to engage with the receiving portions 182a, 182b. Similarly, the radius RC1 of the clamping portions 390a, 390b of the jaw assembly 338 is greater than the radius of curvature RB2 of the receiving portions 282a, 282b of the press ring 270 such that the clamping portions 390a, 390b of the jaw assembly 338 visually alert the operator that the clamping portions 390a, 390b are unable to engage the receiving portions 282a, 282b. In addition to the greater radius of RC1 compared to RA2 and RB2, the first and second clamping portions 390a, 390b of the jaw assembly 338 can also not be received by the receiving portions 182a, 182b or 282a, 282b because the distance DC2 between the clamping portions 390a, 390b of the jaw assembly 338 in the closed configuration is greater than the width WA1 between the receiving portions 182a, 182b of the press ring 170 in the open configuration and the width WB1 between the receiving portions 282a, 282b of the press ring 238 in the open configuration.

Although the invention has been described in detail with reference to certain preferred embodiments, variations and modifications exist within the scope and spirit of one or more independent aspects of the invention as described.

Various features of the invention are set forth in the following claims.

What is claimed is:

1. A press tool assembly configured to crimp a fitting to a pipe, the press tool assembly comprising:
a press tool including
a housing,
a drive unit supported within the housing,
a clevis coupled to the housing and extending therefrom,
a trigger configured to selectively activate the drive unit to initiate a crimping operation,
a first jaw assembly configured to be selectively coupled to the clevis and having a first jaw defining a first clamping portion and a second jaw defining a second clamping portion, the first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance, and
a second jaw assembly configured to be selectively coupled to the clevis and having a third jaw defining a third clamping portion and a fourth jaw defining a fourth clamping portion, the third jaw and the fourth jaw being pivotable between an open configuration, where the third clamping portion and the fourth clamping portion are separated from each other by a third distance that is greater than the first distance, and a closed configuration, where the third clamping portion and the fourth clamping portion are separated from each other by a fourth distance that is less than the third distance; and
a press ring having a plurality of links pivotably coupled to each other and configured to surround the fitting, the press ring having a first receiving portion defined in a first link and a second receiving portion defined in a second link, the first and second receiving portions configured to respectively receive the first and second clamping portions of the first jaw assembly, the press ring movable between an open configuration, where the first and second receiving portions are separated by a first width, and a closed configuration, where the first and second receiving portions are separated by a second width less than the first width,
wherein the fourth distance is greater than the first width so the third and fourth clamping portions are unable to engage the first and second receiving portions when the second jaw assembly is coupled to the clevis and is in the closed configuration.

2. The press tool assembly of claim 1, wherein the press ring is a first press ring, and wherein the press tool assembly further comprises a second press ring having a plurality of links pivotably coupled to each other and configured to surround the fitting, wherein the second press ring has a third receiving portion defined in a first link of the second press ring and a fourth receiving portion defined in a second link of the second press ring, wherein the third and fourth receiving portions are configured to respectively receive the third and fourth clamping portions of the second jaw assembly when coupled to the clevis.

3. The press tool assembly of claim 2, wherein the second press ring is movable between an open configuration, where the third and fourth receiving portions are separated by a third width, and a closed configuration, where the third and fourth receiving portions are separated by a fourth width, and wherein the third width is greater than the first distance of the first jaw assembly so the first and second clamping portions are unable to engage with the third and fourth receiving portions, respectively, when the first jaw assembly is coupled to the clevis and in the open configuration.

4. The press tool assembly of claim 3, wherein the first, second, third, and fourth receiving portions are defined by a recess having an innermost portion and an outermost edge, wherein the first width and the second width are each defined between the innermost portion of the first and second receiving portions, and wherein the third width and the fourth width are each defined between the outermost edge of the third and fourth receiving portions.

5. The press tool assembly of claim 3, wherein
the first and second receiving portions are each defined as a recess having a first radius of curvature,
the third and fourth receiving portions are each defined as a recess having a second radius of curvature,
the first and second clamping portions are each defined as protrusions having a first radius, and
the third and fourth clamping portions are each defined as protrusions having a second radius.

6. The press tool assembly of claim 5, wherein the first radius is less than the second radius, wherein the first radius of curvature is less than the second radius of curvature, and wherein the second radius is greater than the first radius of curvature such that the third and fourth clamping portions visually alert the operator that the third and fourth clamping portions are unable to engage with the first and second receiving portions when the second jaw assembly is coupled to the clevis.

7. The press tool assembly of claim 6, wherein the first radius is less than the second radius of curvature such that the first and second clamping portions visually alert the operator that the first and second clamping portions are unable to engage with the third and fourth receiving portions when the first jaw assembly is coupled to the clevis.

8. A press tool assembly configured to crimp a fitting to a pipe, the press tool assembly comprising:
a press tool including
a housing,
a drive unit supported within the housing,
a clevis coupled to the housing and extending therefrom,
a trigger configured to selectively activate the drive unit to initiate a crimping operation, and
a first jaw assembly coupled to the clevis and having a first jaw defining a first clamping portion and a second jaw defining a second clamping portion, the first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance,
a first press ring having a plurality of links pivotably coupled to each other and configured to surround the fitting, the first press ring having a first receiving portion defined in a first link and a second receiving portion defined in a second link, the first and second receiving portions configured to respectively receive the first and second clamping portions of the first jaw assembly, the first press ring movable between an open configuration where the first and second receiving portions are separated by a first width and a closed configuration where the first and second receiving portions are separated by a second width; and
a second press ring having a plurality of links pivotably coupled to each other and configured to surround the fitting, the second press ring having a third receiving portion defined in a first link and a fourth receiving portion defined in a second link, the second press ring movable between an open configuration where the third and fourth receiving portions are separated by a third width and a closed configuration where the third and fourth receiving portions are separated by a fourth width,
wherein the third width is greater than the first distance such that the first and second clamping portions are unable to engage with the third and fourth receiving portions of the second press ring.

9. The press tool assembly of claim 8, wherein the first, second, third, and fourth receiving portions are defined by a recess having an innermost portion and an outermost edge, wherein the first width and the second width are each defined between the innermost portion of the first and second receiving portions, and wherein the third width and the fourth width are each defined between the outermost edge of the third and fourth receiving portions.

10. The press tool assembly of claim 8, wherein the first jaw assembly is integrated with the clevis of the press tool.

11. The press tool assembly of claim 8, wherein the first jaw assembly is removably coupled to the clevis of the press tool.

12. The press tool assembly of claim 9, wherein
the first and second receiving portions are each defined as a recess having a first radius of curvature,
the third and fourth receiving portions are each defined as a recess having a second radius of curvature,
the first and second clamping portions are each defined as protrusions having a first radius, and
the third and fourth clamping portions are each defined as protrusions having a second radius.

13. The press tool assembly of claim 12, wherein the first radius is less than the second radius, wherein the first radius of curvature is less than the second radius of curvature, and wherein the second radius is greater than the first radius of curvature such that the third and fourth clamping portions visually alert the operator that the third and fourth clamping portions are unable to engage with the first and second receiving portions when the second jaw assembly is coupled to the clevis.

14. The press tool assembly of claim 12, wherein the first radius is less than the second radius of curvature such that the first and second clamping portions visually alert the operator that the first and second clamping portions are unable to engage with the third and fourth receiving portions when the first jaw assembly is coupled to the clevis.

15. A press tool assembly configured to crimp a fitting to a pipe, the press tool assembly comprising:
a first jaw assembly configured to be coupled to the press tool and having a first jaw defining a first clamping portion and a second jaw defining a second clamping portion, the first jaw and the second jaw being pivotable between an open configuration, where the first clamping portion and the second clamping portion are separated from each other by a first distance, and a closed configuration, where the first clamping portion and the second clamping portion are separated from each other by a second distance that is less than the first distance;
a second jaw assembly configured to be coupled to the press tool and having a third jaw defining a third clamping portion and a fourth jaw defining a fourth clamping portion, the third jaw and the fourth jaw being pivotable between an open configuration, where the third clamping portion and the fourth clamping portion are separated from each other by a third distance that is greater than the first distance, and a closed configuration, where the third clamping portion and the fourth clamping portion are separated from each other by a fourth distance that is less than the third distance;
a first press ring having a plurality of links pivotably coupled to each other and configured to surround the fitting, the first press ring having a first receiving portion defined in a first link and a second receiving portion defined in a second link, the first and second receiving portions configured to respectively receive the first and second clamping portions of the first jaw assembly, the first press ring movable between an open configuration where the first and second receiving portions are separated by a first width and a closed configuration where the first and second receiving portions are separated by a second width; and
a second press ring having a plurality of links pivotably coupled to each other and configured to surround the fitting, the second press ring having a third receiving portion defined in a first link and a fourth receiving portion defined in a second link, the second press ring movable between an open configuration where the third and fourth receiving portions are separated by a third width and a closed configuration where the third and fourth receiving portions are separated by a fourth width,
wherein the first distance is less than the third width so the first and second clamping portions are unable to engage the third and fourth receiving portions of the second press ring when the first jaw assembly is coupled to the press tool, and
wherein the fourth distance is greater than the first width such that the third and fourth clamping portions are unable to engage with the first and second receiving portions of the first press ring when the second jaw assembly is coupled to the press tool.

16. The press tool assembly of claim 15, wherein the first, second, third, and fourth receiving portions are defined by a recess having an innermost portion and an outermost edge, wherein the first width and the second width are each defined between the innermost portion of the first and second receiving portions, and wherein the third width and the fourth width are each defined between the outermost edge of the third and fourth receiving portions.

17. The press tool assembly of claim 16, wherein
the first and second receiving portions are each defined as a recess having a first radius of curvature,
the third and fourth receiving portions are each defined as a recess having a second radius of curvature,
the first and second clamping portions are each defined as protrusions having a first radius, and
the third and fourth clamping portions are each defined as protrusions having a second radius.

18. The press tool assembly of claim 17, wherein the first radius is less than the second radius, wherein the first radius of curvature is less than the second radius of curvature, and wherein the second radius is greater than the first radius of curvature such that the third and fourth clamping portions visually alert the operator that the third and fourth clamping portions are unable to engage with the first and second receiving portions when the second jaw assembly is coupled to the clevis.

19. The press tool assembly of claim 18, wherein the first radius is less than the second radius of curvature such that the first and second clamping portions visually alert the operator that the first and second clamping portions are unable to engage with the third and fourth receiving portions when the first jaw assembly is coupled to the clevis.

20. The press tool assembly of claim 15, wherein the press tool includes a drive unit, a clevis configured to removably receive the first jaw assembly or the second jaw assembly, and a trigger configured to selectively activate the drive unit to initiate a crimping operation.
